(19) United States
(12) Patent Application Publication
(10) Pub. No.: US 2025/0271708 A1
(43) Pub. Date: Aug. 28, 2025

(54) DISPLAY PANEL

(71) Applicant: HannStar Display Corporation, Taipei City (TW)

(72) Inventors: Jing-Ya Chiu, Taipei City (TW); Qi-En Luo, Taipei City (TW); Ying-Jung Chen, Taipei City (TW); Shao-Chien Chang, Taipei City (TW); Ling Chih Kao, Taipei City (TW); Cheng-Yen Yeh, Taipei City (TW)

(73) Assignee: HannStar Display Corporation, Taipei City (TW)

(21) Appl. No.: 18/943,831

(22) Filed: Nov. 11, 2024

Related U.S. Application Data
(60) Provisional application No. 63/558,094, filed on Feb. 26, 2024.

(30) Foreign Application Priority Data
May 23, 2024 (TW) 113119111

(51) Int. Cl. G02F 1/1343; G02F 1/1335; G02F 1/1339

(52) U.S. Cl. CPC G02F 1/134318; G02F 1/133553; G02F 1/13394

(57) ABSTRACT

A display panel including a first substrate, a second substrate, a liquid crystal layer, data lines, scan lines, pixel structures, a first common electrode layer, bridge patterns, first spacers, and a second common electrode layer is provided. The liquid crystal layer is disposed between the first substrate and the second substrate. The data lines and the scan lines are disposed on the first substrate and intersect each other. Each of the pixel structures has an active device and a pixel electrode. The first common electrode layer and the bridge patterns are disposed on the first substrate and electrically connected to each other. The first common electrode layer overlaps the pixel structures. The first spacers are disposed on the second substrate and respectively abut the bridge patterns. The second common electrode layer disposed on the second substrate covers the first spacers to electrically connect the bridge patterns.

### CROSS-REFERENCE TO RELATED APPLICATION

This application claims the priority benefit of U.S. provisional application Ser. No. 63/558,094, filed on Feb. 26, 2024, and Taiwan application serial no. 113119111, filed on May 23, 2024. The entirety of each of the above-mentioned patent applications is hereby incorporated by reference herein and made a part of this specification.

### BACKGROUND

### Technical Field

The disclosure relates to a display technology, and in particular to a display panel.

### Description of Related Art

In a current display panel, the common electrode layers of the pixel structures are connected to each other and form a storage capacitor with each of the pixel electrodes. As the size and resolution of display panels continue to be improved, the capacitive coupling effect between the common electrode layer and other conductive layers will cause a delay in the transmission of electrical signals on the common electrode layer, causing the voltage level of the common electrode layer to generate deviation as moving away from the electrical signal source. The deviation in the voltage level may lead to insufficient storage capacitor of the display pixels and affect the display quality.

### SUMMARY

The disclosure provides a display panel with favorable operating electrical properties.

The display panel of the disclosure includes a first substrate, a second substrate, a liquid crystal layer, multiple data lines, multiple scan lines, multiple pixel structures, a first common electrode layer, multiple bridge patterns, multiple first spacers, and a second common electrode layer. The first substrate and the second substrate are disposed along a stacking direction. The liquid crystal layer is disposed between the first substrate and the second substrate. The data lines and the scan lines are disposed on the first substrate and intersect each other. The pixel structures are disposed on the first substrate, and each has an active device and a pixel electrode. The active component is electrically connected to the pixel electrode, one of the data lines and one of the scan lines. The first common electrode layer and the bridge patterns are disposed on the first substrate and are electrically connected to each other. The first common electrode layer overlaps the pixel structures. The first spacers are disposed on the second substrate and respectively abut the bridge patterns along the stacking direction. The second common electrode layer is disposed on the second substrate and covers the first spacers to be electrically connected to the bridge patterns.

In an embodiment of the disclosure, the first common electrode layer of the display panel has multiple openings. The openings respectively overlap the pixel electrodes of the pixel structures along the stacking direction.

In an embodiment of the disclosure, the bridge patterns of the display panel and the pixel electrodes of the pixel structures are of a same film layer.

In an embodiment of the disclosure, the first common electrode layer of the display panel overlaps the pixel electrodes of the pixel structures.

In an embodiment of the disclosure, each of the pixel structures of the display panel further has a first transfer pattern, which is disposed between the pixel electrode and the active device. The pixel electrode is electrically connected to the active device through the first transfer pattern. A second transfer pattern is disposed between each of the bridge patterns and the first common electrode layer. Each of the bridge patterns is electrically connected to the first common electrode layer through the second transfer pattern. The first transfer pattern and the second transfer pattern are of a same film layer.

In an embodiment of the disclosure, each of the pixel structures of the display panel further has a capacitor electrode, which is electrically connected to the active device and the first transfer pattern. The capacitor electrode is capacitively coupled with the first common electrode layer and forms a storage capacitor.

In an embodiment of the disclosure, each of the pixel structures of the display panel further has a reflective layer. The reflective layer has an opening that overlaps the pixel electrodes, and the reflective layer defines a reflective area of each of the pixel structures. The opening of the reflective layer defines a light transmission area of each of the pixel structures. An orthographic projection of the opening on the substrate surface of the first substrate is located within an orthographic projection of the pixel electrode on the substrate surface.

In an embodiment of the disclosure, the bridge patterns and the reflective layer of each of the pixel structures of the display panel are of a same film layer.

In an embodiment of the disclosure, a transfer pattern is disposed between each of the bridge patterns and the first common electrode layer of the display panel. Each of the bridge patterns is electrically connected to the first common electrode layer through the transfer pattern. The transfer pattern and the pixel electrode are of a same film layer.

In an embodiment of the disclosure, the first common electrode layer of the display panel is capacitively coupled to the pixel electrode and forms the storage capacitor.

In an embodiment of the disclosure, the display panel further includes multiple second spacers, which are disposed on the second substrate and overlap the pixel structures. The first spacers and the second spacers are of a same film layer.

In an embodiment of the disclosure, the display panel further includes multiple the second spacers, which are disposed on the second substrate and located on a side of the second common electrode layer facing away from the second substrate.

Based on the above, in the display panel according to an embodiment of the disclosure, the bridge patterns electrically connected to the first common electrode layer are disposed on the first substrate. The second common electrode layer and the first spacers suitable for respectively abutting the bridge patterns are dispose on the second substrate. By covering the first spacers with the second common electrode layer to be in electrical contact with the bridge patterns and realizing the electrical connection between the first common electrode layer and the second common electrode layer, the voltage level difference in different areas of the first common electrode layer that overlaps the pixel structures can be effectively reduced, thereby improving the distribution uniformity of the voltage level of the first common electrode layer.

### BRIEF DESCRIPTION OF THE DRAWINGS

FIG. 1 is a schematic front view of a display panel according to the first embodiment of the disclosure.

FIGS. 2 and 3 are schematic cross-sectional views of the display panel of FIG. 1.

FIG. 4 is a schematic cross-sectional view of another modified embodiment of the display panel of FIG. 3.

FIG. 5 is a schematic front view of a display panel according to the second embodiment of the disclosure.

FIGS. 6 and 7 are schematic cross-sectional views of the display panel of FIG. 5.

FIG. 8 is a schematic front view of a display panel according to the third embodiment of the disclosure.

FIGS. 9 and 10 are schematic cross-sectional views of the display panel of FIG. 8.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting.

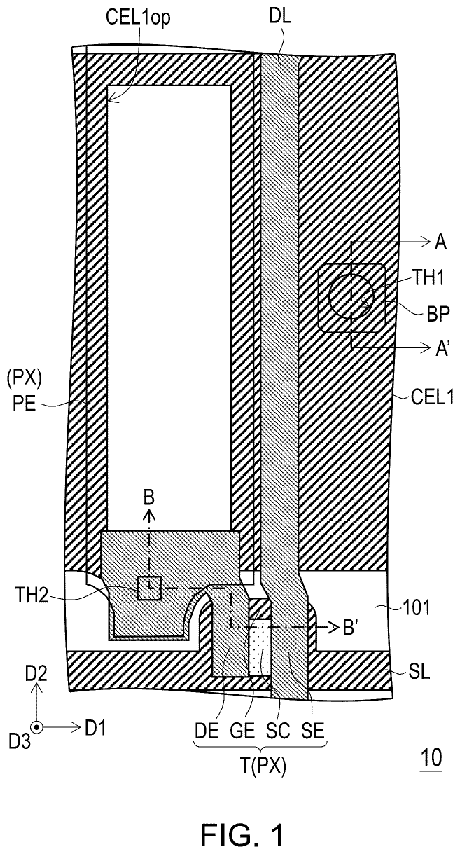

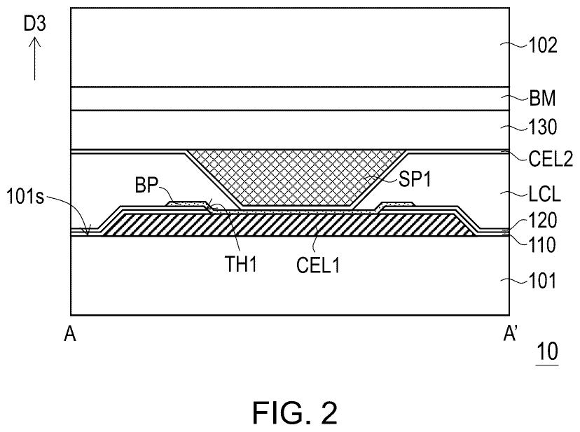

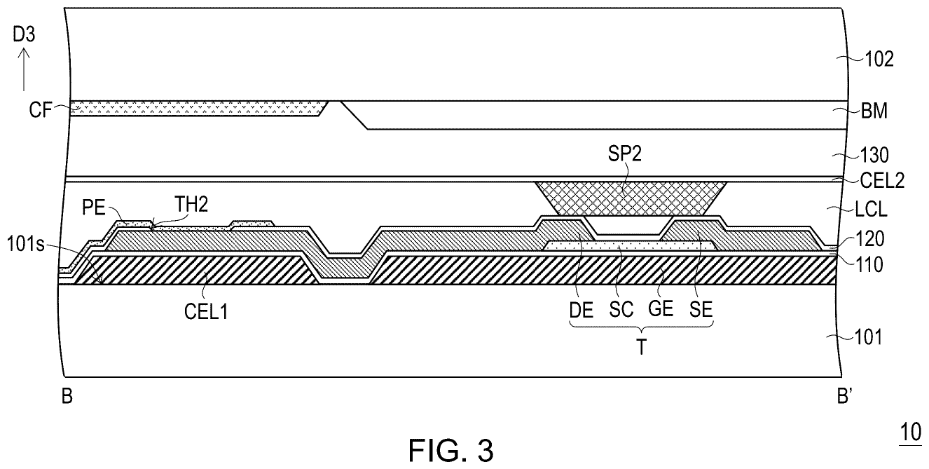

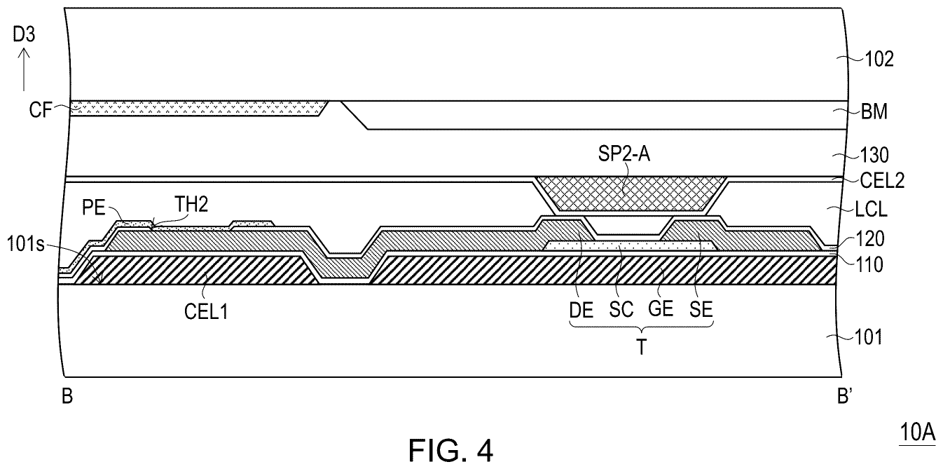

FIG. 1 is a schematic front view of a display panel according to the first embodiment of the disclosure. FIGS. 2 and 3 are schematic cross-sectional views of the display panel of FIG. 1. FIG. 4 is a schematic cross-sectional view of another modified embodiment of the display panel of FIG. 3. FIGS. 2 and 3 respectively correspond to a cross-section line AA′ and a cross-section line BB′ of FIG. 1. For clarity, FIG. 1 only shows part of the film layers in FIGS. 2 and 3.

Referring to FIGS. 1 to 3, a display panel 10 includes a first substrate 101, a second substrate 102, and a liquid crystal layer LCL. The first substrate 101 and the second substrate 102 are disposed to overlap along a stacking direction (e.g., a direction D3). The liquid crystal layer LCL is disposed between the first substrate 101 and the second substrate 102. Unless otherwise mentioned below, the overlapping relationship between the two components is defined by the aforementioned stacking direction, and the overlapping direction is not described again.

It should be understood that although the display panel 10 in FIG. 1 only shows one pixel structure PX, one data line DL, and one scan line SL, the display panel 10 is actually provided with multiple pixel structures PX, multiple data lines DL, and multiple scan lines SL. For example, the data lines DL may be arranged on the first substrate 101 along a direction D1 and extend in a direction D2. The scan lines SL may be arranged on the first substrate 101 along the direction D2 and extend in the direction D1. More specifically, the data lines DL and the scan lines SL intersect each other and define multiple pixel areas of the display panel 10. The pixel structures PX respectively correspond to the pixel areas and are disposed on the first substrate 101, and are each electrically connected to one scan line SL and one data line DL. For example, the pixel structures PX may be arranged in multiple columns and rows along the direction D1 and the direction D2 respectively. That is, the pixel structures PX are arranged in an array on the first substrate 101.

In detail, each of the pixel structures PX has an active device T and a pixel electrode PE that are electrically connected to each other. In this embodiment, a method of forming the active device T may include the following steps. A gate GE, a gate insulating layer 110, a semiconductor pattern SC, a source SE, and a drain DE are sequentially formed on the first substrate 101. The semiconductor pattern SC is disposed to overlap the gate GE. The source SE and the drain DE overlap the semiconductor pattern SC and are in electrical contact with two different areas of the semiconductor pattern SC. In this embodiment, the gate GE of the active device T may be selectively disposed under the semiconductor pattern SC to form a bottom-gate thin film transistor (bottom-gate TFT), but is not limited thereto. In other embodiments, the gate of the active device may also be selectively disposed above the semiconductor pattern to form a top-gate thin film transistor (top-gate TFT). Furthermore, the active device T may be covered with an insulating layer 120. In this embodiment, the insulating layer 120 is, for example, a passivation layer.

It should be noted that the gate GE, the source SE, the drain DE, the semiconductor pattern SC, the gate insulating layer 110, and the passivation layer (i.e., the insulating layer 120) may be realized by any gate, any source, any drain, any semiconductor pattern, any gate insulating layer, and any passivation for display known to those skilled in the art. The gate GE, source SE, drain DE, the semiconductor pattern SC, the gate insulating layer 110, and the passivation layer may be formed by any method well known to those skilled in the art, and thus is not repeated herein.

In this embodiment, the pixel electrode PE is disposed on the insulating layer 120 and is electrically connected to the drain DE of the active device T through a contact hole TH2 of the insulating layer 120. In this embodiment, the pixel electrode PE is, for example, a light-transmitting electrode, and a material of the light-transmitting electrode includes metal oxide, such as indium tin oxide, indium zinc oxide, aluminum tin oxide, aluminum zinc oxide, or other suitable oxide, or a stacked layer of at least two of the above. More specifically, the display panel 10 of this embodiment may be a light-transmitting liquid crystal display panel, but is not limited thereto.

Further, the display panel 10 may further include a first common electrode layer CEL1 and multiple bridge patterns BP that are electrically connected to each other. The first common electrode layer CELL is disposed between the first substrate 101 and the gate insulating layer 110 and overlaps the pixel structures PX. In detail, the first common electrode layer CELL has multiple openings CEL1op, and the openings CEL1op respectively overlap the pixel electrodes PE of the pixel structures PX. It is particularly noted that, in addition to overlapping the opening CEL1op of the first common electrode layer CELL, the pixel electrode PE also overlaps a surrounding portion defining the opening CEL1op in the first common electrode layer CELL to form a storage capacitor of the pixel structure PX. In this embodiment, the first common electrode layer CELL and the gate electrode GE may be of a same film layer, but are not limited thereto.

An orthographic projection of the bridge pattern BP on a substrate surface 101s of the first substrate 101 is located within the orthographic projection of the first common electrode layer CEL1 on the substrate surface 101s. That is, the bridge pattern BP completely overlaps the first common electrode layer CEL1. In this embodiment, the bridge pattern BP is disposed on the insulating layer 120 and is electrically connected to the first common electrode layer CEL1 through a contact hole TH1 of the gate insulating layer 110 and the insulating layer 120. For example, the bridge pattern BP and the pixel electrode PE may be of a same film layer to avoid additional manufacturing steps.

On the other hand, a second common electrode layer CEL2 is disposed on the second substrate 102. The second common electrode layer CEL2 is, for example, a light-transmitting electrode. For example, when the display panel 10 performs a display operation, an electric field generated between the second common electrode layer CEL2 and the pixel electrode PE of each of the pixel structures PX is suitable for driving multiple liquid crystal molecules (not shown) of the liquid crystal layer LCL to rotate to form an arrangement state corresponding to the direction and intensity of the electric field. By changing the arrangement state of the liquid crystal molecules, a polarization state of the light passing through the liquid crystal layer LCL is changed to form a light exiting luminance corresponding to the arrangement state. In this embodiment, the liquid crystal layer LCL is driven in a twisted nematic (TN) mode or an electrically controlled birefringence (ECB) mode.

In order to separate a cavity for accommodating the liquid crystal layer LCL between the first substrate 101 and the second substrate 102, multiple first spacers SP1 and multiple second spacers SP2 are further disposed on the second substrate 102. The first spacers SP1 are respectively disposed to overlap the bridge patterns BP on the first substrate 101, and are suitable for respectively abutting the bridge patterns BP (as shown in FIG. 2). The second spacers SP2 may be respectively disposed to overlap the active devices T on the first substrate 101, and are suitable for respectively abutting the active devices T (as shown in FIG. 3). However, the disclosure is not limited thereto. In other embodiments not shown, the second spacers SP2 may also be disposed to overlap the pixel electrodes PE, and part of the second spacers SP2 may not abut the pixel electrodes PE. That is, the second spacers SP2 may have different heights.

It is particularly noted that the second common electrode layer CEL2 may realize the electrical connection relationship thereof with the bridge patterns BP by covering the bridge patterns BP. From another point of view, the first common electrode layer CELL on the first substrate 101 may be electrically connected to the second common electrode layer CEL2 on the second substrate 102 through the abut relationship between the bridge pattern BP and the first spacer SP1. Accordingly, a voltage level difference in different areas of the first common electrode layer CELL that simultaneously overlaps the pixel structures PX can be effectively reduced, thereby improving a distribution uniformity of a voltage level of the first common electrode layer CEL1.

On the other hand, in this embodiment, the second spacers SP2 may be disposed on a side of the second common electrode layer CEL2 facing away from the second substrate 102 (as shown in FIG. 3). That is, the second spacer SP2 and the first spacer SP1 may be on different film layers. For example, the first spacer SP1 and the second spacer SP2 may be manufactured using two masks respectively. Through such a design, a risk of electrical short circuit between the second common electrode layer CEL2 and the electronic components on the first substrate 101 due to excessive extrusion of the second spacer SP2 by external force can be avoided. In other words, the design flexibility of the second spacer SP2 can be enhanced.

However, the disclosure is not limited thereto. In another modified embodiment, a second spacer SP2-A of a display panel 10A and the first spacer SP1 of FIG. 2 may be of a same film layer, and both are located between the second common electrode layer CEL2 and the second substrate 102 (as shown in FIG. 4). For example, the first spacer SP1 and the second spacer SP2 may be manufactured using the same mask, such as a half-tone mask.

In this embodiment, multiple color filter patterns CF, a light-shielding pattern layer BM, and a cladding layer 130 may further be selectively disposed on the second substrate 102. The color filter patterns CF respectively overlap the pixel electrodes PE and are suitable for allowing multiple color lights (such as red lights, green lights, and blue lights, but not limited thereto) to pass through. However, the disclosure is not limited thereto. In other embodiments, the color filter pattern CF may not be provided on the second substrate 102. In this embodiment, the cladding layer 130 covers the color filter patterns CF and the light-shielding pattern layer BM. The second spacers SP2 and the second common electrode layer CEL2 are disposed on the cladding layer 130.

In the following, other embodiments are provided to explain the disclosure in detail. The same members are labeled with the same reference numerals, and description of the same technical content is omitted. For the omitted parts, please refer to the above embodiments, which are not repeated herein.

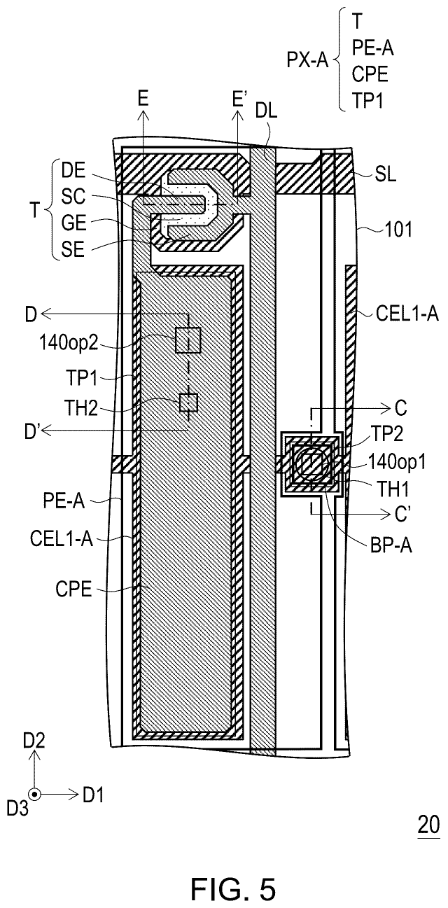

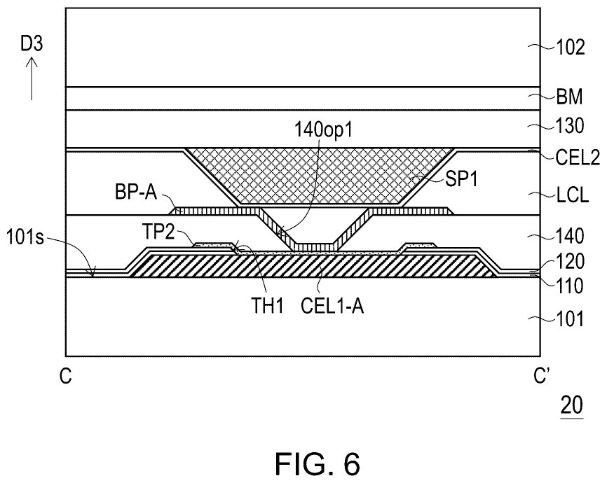

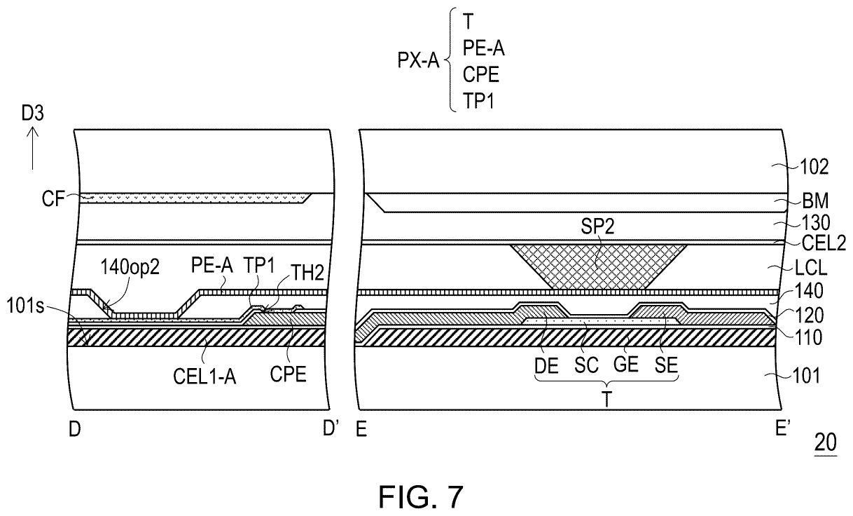

FIG. 5 is a schematic front view of a display panel according to the second embodiment of the disclosure. FIGS. 6 and 7 are schematic cross-sectional views of the display panel of FIG. 5. FIG. 6 corresponds to a cross-section line CC′ of FIG. 5. FIG. 7 corresponds to a cross-section line DD′ and a cross-section line EE′ of FIG. 5. For clarity, FIG. 5 only shows part of the film layers in FIGS. 6 and 7.

Referring to FIGS. 5 to 7, the main differences between a display panel 20 of this embodiment and the display panel 10 of FIGS. 1 to 3 are: the design of the pixel structure and a bridging film layer structure of the first common electrode layer and the second common electrode layer are different. Specifically, in this embodiment, a pixel structure PX-A of the display panel 20 may further include a capacitor electrode CPE and a first transfer pattern TP1.

In detail, the capacitor electrode CPE is disposed between the gate insulating layer 110 and the insulating layer 120 and extends from the drain DE of the active device T. That is, the capacitor electrode CPE is electrically connected to the drain DE of the active device T. The first transfer pattern TP1 is disposed on the insulating layer 120 and is electrically connected to the capacitor electrode CPE through the contact hole TH2 of the insulating layer 120. In this embodiment, a flat layer 140 may further be disposed on the insulating layer 120. A pixel electrode PE-A of the pixel structure PX-A may be disposed on the flat layer 140 and is electrically connected to the first transfer pattern TP1 through an opening 140op2 of the flat layer 140.

That is to say, the pixel electrode PE-A of this embodiment is electrically connected to the active device T through the first transfer pattern TP1 and the capacitor electrode CPE. In this embodiment, the flat layer may be implemented by any flat layer for display panels that is well known to those skilled in the art, and the flat layer may be formed by any method known to those skilled in the art, and therefore is not repeated herein.

It is particularly noted that the orthographic projection of the capacitor electrode CPE on the first substrate 101 is located within the orthographic projection of a first common electrode layer CEL1-A on the first substrate 101, and the gate insulating layer 110 is disposed between the two. More specifically, the capacitor electrode CPE is capacitively coupled with the first common electrode layer CEL1-A and forms a storage capacitor of the pixel structure PX-A.

In this embodiment, the pixel electrode PE-A is, for example, a reflective electrode, and a material of the reflective electrode includes metal, alloy, nitride of metal material, oxide of metal material, oxynitride of metal material, or other suitable materials, or a stacked layer of metal materials and other conductive materials. That is to say, the display panel 20 of this embodiment may be a reflective liquid crystal display panel, but is not limited thereto. Therefore, the first common electrode layer CEL1-A of this embodiment further overlaps the pixel electrode PE-A, but without an opening (the opening CEL1op shown in FIG. 1) that overlaps the pixel electrode PE-A.

On the other hand, in this embodiment, a second transfer pattern TP2 is disposed between a bridge pattern BP-A and the first common electrode layer CEL1-A. The bridge pattern BP-A is electrically connected to the first common electrode layer CEL1-A through the second transfer pattern TP2. In detail, the second transfer pattern TP2 may be disposed between the insulating layer 120 and the flat layer 140, and is electrically connected to the first common electrode layer CEL1-A through the gate insulating layer 110 and the contact hole TH1 of the insulating layer 120. The bridge pattern BP-A is disposed on the flat layer 140 and is electrically connected to the second transfer pattern TP2 through an opening 140op1 of the flat layer 140.

In this embodiment, the bridge pattern BP-A and the pixel electrode PE-A may be of a same film layer. The second transfer pattern TP2 and the first transfer pattern TP1 may be of a same film layer. In this way, additional manufacturing steps can be avoided.

Since the first common electrode layer CEL1-A of this embodiment is also electrically connected to the second common electrode layer CEL2 on the second substrate 102 through the abut relationship between the first spacer SP1 and the bridge pattern BP-A, the voltage level difference in different areas of the first common electrode layer CEL-A that simultaneously overlaps the pixel structures PX-A can be effectively reduced, thereby improving the distribution uniformity of the voltage level of the first common electrode layer CEL1-A. In this way, the operating electrical properties of the display panel 20 can be improved.

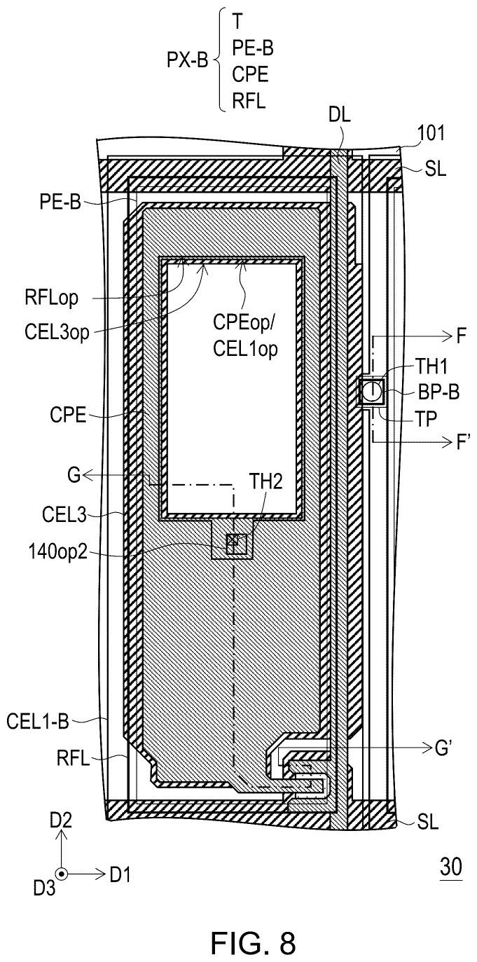

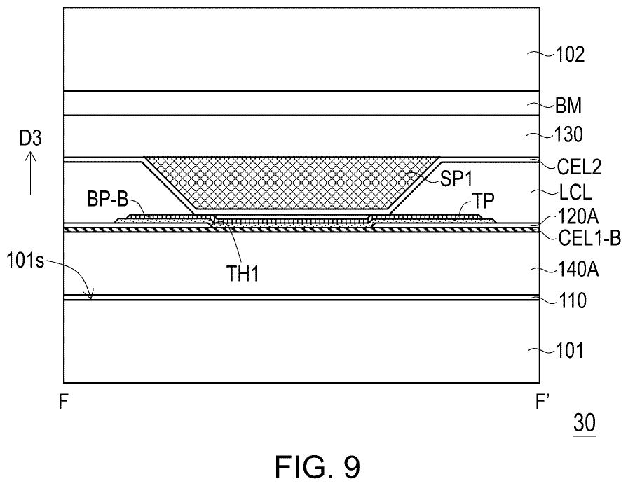

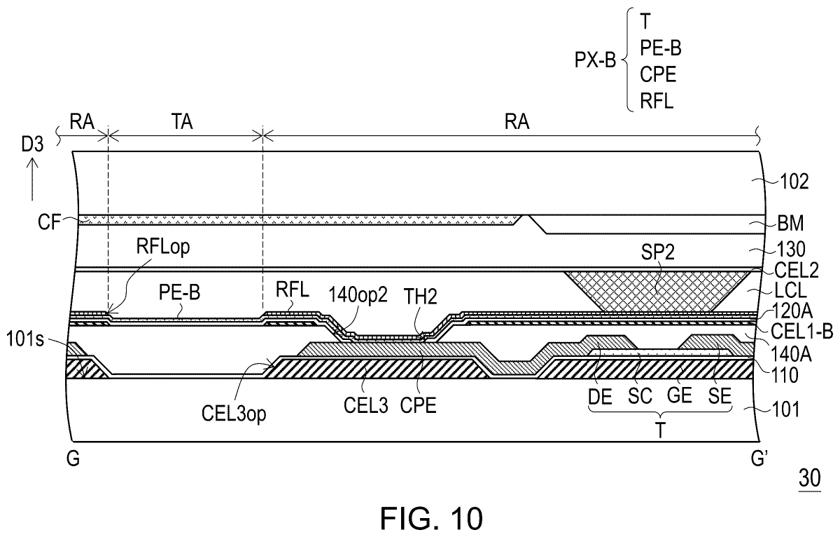

FIG. 8 is a schematic front view of a display panel according to the third embodiment of the disclosure. FIGS. 9 and 10 are schematic cross-sectional views of the display panel of FIG. 8. FIGS. 9 and 10 respectively correspond to a cross-section line FF′ and a cross-section line G-G′ in FIG. 8. For clarity, FIG. 8 only shows part of the film layers in FIGS. 9 and 10.

Referring to FIGS. 8 to 10, the main differences between a display panel 30 of this embodiment and the display panel 20 of FIGS. 5 to 7 are: the design of the pixel structure and the bridging film layer structure of the first common electrode layer and the second common electrode layer are different. Specifically, in this embodiment, a pixel structure PX-B of the display panel 30 is not provided with the first transfer pattern TP1 as shown in FIG. 7, but further includes a reflective layer RFL.

In this embodiment, a pixel electrode PE-B is, for example, a light-transmitting electrode. The reflective layer RFL is disposed on the pixel electrode PE-B and is directly in electrical contact therewith. The reflective layer RFL has an opening RFLop that overlaps the pixel electrode PE-B. The reflective layer RFL may define a reflective area RA of the pixel structure PX-B, and the opening RFLop may define a light transmission area TA of the pixel structure PX-B. It is particularly noted that the orthographic projection of the opening RFLop of the reflective layer RFL on the substrate surface 101s of the first substrate 101 is located within the orthographic projection of the pixel electrode PE-B on the substrate surface 101s. More specifically, the display panel 30 of this embodiment may be a transflective liquid crystal display panel or a micro transflective liquid crystal display panel.

On the other hand, in this embodiment, a first common electrode layer CEL1-B is disposed on the active device T. In detail, the active device T may be covered with a flat layer 140A. The first common electrode layer CEL1-B is disposed on the flat layer 140A and covered by an insulating layer 120A. It is particularly noted that in this embodiment, the contact hole TH2 of the insulating layer 120A overlaps the opening 140op2 of the flat layer 140A. The pixel electrode PE-B and the reflective layer RFL may extend into the opening 140op2 of the flat layer 140A and be electrically connected to the capacitor electrode CPE through the contact hole TH2 of the insulating layer 120A.

It is particularly noted that the orthographic projection of the capacitor electrode CPE on the first substrate 101 is located within the orthographic projection of the first common electrode layer CEL1-B on the first substrate 101, and the flat layer 140A is disposed therebetween. The orthographic projection of the capacitor electrode CPE on the first substrate 101 is located within the orthographic projection of the pixel electrode PE-B on the first substrate 101, and the insulating layer 120A is disposed therebetween.

On the other hand, in this embodiment, the display panel 30 may further include a third common electrode layer CEL3 disposed between the gate insulating layer 110 and the first substrate 101 (that is, the third common electrode layer CEL3 and the gate GE may be of a same film layer). The orthographic projection of the capacitor electrode CPE on the first substrate 101 is located within the orthographic projection of the third common electrode layer CEL3 on the first substrate 101, and the gate insulating layer 110 is disposed therebetween.

More specifically, the capacitor electrode CPE is capacitively coupled with the first common electrode layer CEL1-B and forms the first one of the storage capacitors of the pixel structure PX-B. The first common electrode layer CEL1-B is capacitively coupled with the pixel electrode PE-B and forms the second one of the storage capacitors of the pixel structure PX-B. The capacitor electrode CPE is capacitively coupled with the third common electrode layer CEL3-B and forms the third one of the storage capacitors of the pixel structure PX-B. In other words, compared with the pixel structure PX-A of FIG. 5 having only one storage capacitor, the pixel structure PX-B of this embodiment may have three storage capacitors connected in parallel. Therefore, a storage capacitance of the pixel structure PX-B can be greatly enhanced.

In this embodiment, a bridge pattern BP-B is disposed on the insulating layer 120A, and is electrically connected to the first common electrode layer CEL1-B through a transfer pattern TP and the contact hole TH1 of the insulating layer 120A. For example, in order to avoid additional manufacturing steps, the bridge pattern BP-B and the reflective layer RFL of the pixel structure PX-B may be of a same film layer, and the transfer pattern TP and the pixel electrode PE-B may be of a same film layer. Therefore, similar to the connection relationship between the reflective layer RFL and the pixel electrode PE-B, the bridge pattern BP-B may be directly in electrical contact with the transfer pattern TP.

Since the first common electrode layer CEL1-B of this embodiment is also electrically connected to the second common electrode layer CEL2 on the second substrate 102 through the abut relationship between the first spacer SP1 and the bridge pattern BP-B, the voltage level difference in different areas of the first common electrode layer CEL-B that simultaneously overlaps the pixel structures PX-B can be effectively reduced, thereby improving the distribution uniformity of the voltage level of the first common electrode layer CEL1-B. In this way, the operating electrical properties of the display panel 30 can be improved.

On the other hand, since the pixel structure PX-B of this embodiment has the light transmission area TA, the first common electrode layer CEL1-B, the capacitor electrode CPE, and the third common electrode layer CEL3 respectively have the opening CEL1op, an opening CPEop, and an opening CEL3op that overlap the light transmission area TA (i.e., the opening RFLop of the reflective layer RFL).

To sum up, in the display panel according to an embodiment of the disclosure, the bridge patterns electrically connected to the first common electrode layer are disposed on the first substrate. The second common electrode layer and the first spacers suitable for respectively abutting the bridge patterns are dispose on the second substrate. By covering the first spacers with the second common electrode layer to be in electrical contact with the bridge patterns and realizing the electrical connection between the first common electrode layer and the second common electrode layer, the voltage level difference in different areas of the first common electrode layer that overlaps the pixel structures can be effectively reduced, thereby improving the distribution uniformity of the voltage level of the first common electrode layer.

What is claimed is:

1. A display panel, comprising:
a first substrate and a second substrate, disposed to overlap along a stacking direction;
a liquid crystal layer, disposed between the first substrate and the second substrate;
a plurality of data lines, disposed on the first substrate;
a plurality of scan lines, disposed on the first substrate and intersecting the plurality of data lines;
a plurality of pixel structures, disposed on the first substrate, wherein each of plurality of pixel structures has an active device and a pixel electrode, the active device is electrically connected to the pixel electrode, one of the plurality of data lines, and one of the plurality of scan lines;
a first common electrode layer, disposed on the first substrate and overlapping the plurality of pixel structures;
a plurality of bridge patterns, disposed on the first substrate and being electrically connected to the first common electrode layer;
a plurality of first spacers, disposed on the second substrate and respectively abutting the plurality of bridge patterns along the stacking direction; and
a second common electrode layer, disposed on the second substrate and covering the first spacers to be electrically connected to the plurality of bridge patterns.

2. The display panel according to claim 1, wherein the first common electrode layer has a plurality of openings, and the plurality of openings respectively overlap the plurality of pixel electrodes of the plurality of pixel structures along the stacking direction.

3. The display panel according to claim 1, wherein the plurality of bridge patterns and the plurality of pixel electrodes of the plurality of pixel structures are of a same film layer.

4. The display panel according to claim 1, wherein the first common electrode layer overlaps the plurality of pixel electrodes of the plurality of pixel structures.

5. The display panel according to claim 4, wherein each of the plurality of pixel structures further has a first transfer pattern disposed between the pixel electrode and the active device, the pixel electrode is electrically connected to the active device through the first transfer pattern, a second transfer pattern is disposed between each of the plurality of bridge patterns and the first common electrode layer, each of the plurality of bridge patterns is electrically connected to the first common electrode layer through the second transfer pattern, and the first transfer pattern and the second transfer pattern are of a same film layer.

6. The display panel according to claim 5, wherein each of the plurality of pixel structures further has a capacitor electrode electrically connected to the active device and the first transfer pattern, and the capacitor electrode is capacitively coupled with the first common electrode layer and forms a storage capacitor.

7. The display panel according to claim 1, wherein each of the plurality of pixel structures further has a reflective layer, the reflective layer has an opening that overlaps the pixel electrode, the reflective layer defines a reflective area of each of the plurality of pixel structures, the opening of the reflective layer defines a light transmission area of each of the plurality of pixel structures, and an orthographic projection of the opening on a substrate surface of the first substrate is located within an orthographic projection of the pixel electrode on the substrate surface.

8. The display panel according to claim 7, wherein the plurality of bridge patterns and the reflective layer of each of the plurality of pixel structures are of a same film layer.

9. The display panel according to claim 7, wherein a transfer pattern is disposed between each of the plurality of bridge patterns and the first common electrode layer, each of the plurality of bridge patterns is electrically connected to the first common electrode layer through the transfer pattern, and the transfer pattern and the pixel electrode are of a same film layer.

10. The display panel according to claim 7, wherein the first common electrode layer is capacitively coupled to the pixel electrode and forms a storage capacitor.

11. The display panel according to claim 1, further comprising:
a plurality of second spacers, disposed on the second substrate and overlapping the plurality of pixel structures, wherein the plurality of first spacers and the plurality of second spacers are of a same film layer.

12. The display panel according to claim 1, further comprising:
a plurality of second spacers, disposed on the second substrate and located on a side of the second common electrode layer facing away from the second substrate.
